(19) United States
(12) Patent Application Publication
(10) Pub. No.: US 2001/0022357 A1
(43) Pub. Date: Sep. 20, 2001

(54) ELECTROCHEMICHROMIC VIOLOGENS

(76) Inventors: PADMA DESARAJU, HOLLAND, MI (US); DESARAJU V. VARAPRASAD, HOLLAND, MI (US); NIALL R. LYNAM, HOLLAND, MI (US); HAMID R. HABIBI, HOLLAND, MI (US)

Correspondence Address: FITZPATRICK CELLA HARPER & SCINTO, 30 ROCKEFELLER PLAZA, NEW YORK, NY, 10112, US

(21) Appl. No.: 08/868,966

(22) Filed: Jun. 5, 1997

Related U.S. Application Data
(63) Continuation of application No. 08/439,643, filed on May 12, 1995, now abandoned.
Application No. 08/439,643 is a continuation of application No. 08/249,360, filed on May 27, 1994, now abandoned.
Application No. 08/249,360 is a continuation of application No. 08/111,588, filed on Aug. 25, 1993, now abandoned.
Application No. 08/111,588 is a continuation of application No. 07/926,388, filed on Aug. 10, 1992, now abandoned.
Application No. 07/926,388 is a continuation of application No. 07/680,917, filed on Apr. 8, 1991, now abandoned.
Application No. 07/680,917 is a continuation-in-part of application No. 07/443,113, filed on Nov. 29, 1989, now Pat. No. 5,140,455.
Application No. 07/443,113 is a continuation-in-part of application No. 07/458,969, filed on Dec. 29, 1989, now Pat. No. 5,151,816.

(51) Int. Cl. G02F 1/00

(52) U.S. Cl. 252/583

(57) ABSTRACT

An electrochemichromic solution containing novel viologen salts as cathodic materials for the redox pair.

The present application is a continuation-in-part of copending U.S. patent application Ser. No. 07/443,113, filed on Nov. 29, 1989, and copending U.S. patent application Ser. No. 07/458,969, filed on Dec. 29, 1989.

### BACKGROUND OF THE INVENTION

1. Field of the Invention

The present invention relates to electrochemichromic viologens useful in electrochemichromic solutions and devices based thereon. Such solutions are well-known and are designed to either color or clear, depending on desired application, under the influence of applied voltage.

Electrochemichromic (ECC) devices have been suggested for use as rearview mirrors in automobiles such that in night driving conditions, application of a voltage would darken the electrochemichromic solution contained in a cell incorporated into the mirror (U.S. Pat. No. 3,280,701, Oct. 25, 1966). Similarly, it has been suggested that windows incorporating such cells could be darkened to block out sunlight, and then allowed to lighten again at night. Electrochemichromic cells have been used as display devices and have been suggested for use as antidazzle and fog-penetrating devices in conjunction with motor vehicle headlamps (British Patent Specification 328017, May 15, 1930).

An electrochemichromic solution in a single compartment electrochemichromic cell normally contains anodic and cathodic electrochemichromically coloring components, which make the cell to become self-erasing and with a high color contrast. Such anodic and cathodic coloring components comprise redox couples selected to exhibit the following reaction:

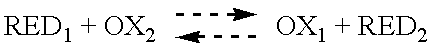

(Colorless) voltage (Colored)

(Low Energy Pair) (High Energy Pair)

The redox couple is selected such that the equilibrium position of the mixture thereof lies completely to the left of the equation. At rest potential, the anodically coloring reductant species RED₁, and the cathodically coloring oxidant species OX₂ are colorless. To cause a color change, voltage is applied and the normally colorless RED₁ is anodically oxidized to its colored antipode OX₁, while, simultaneously, OX₂ is cathodically reduced to its colored antipode, RED₂. These cathodic/anodic reactions occur preferentially at the electrodes which, in practical devices are typically transparent conductive electrodes. Within the bulk of the solution, the redox potentials are such that when RED₂ and OX₁ come together, they revert to their lower energy form.

This means the applied potential need only suffice to drive the above reaction to the right. On removing the potential, the system reverts to its low energy state and the cell spontaneously self-erases.

Such redox pairs are placed in solution in an inert solvent. Typically, an electrolyte is also added. This solution is then placed into a relatively thin cell, between two conductive surfaces. In most applications, at least one of the conductive surfaces comprises a very thin layer of a transparent conductor such as indium tin oxide (ITO), doped tin oxide or doped zinc oxide deposited on a glass substrate so that the cell is transparent from at least one side. If the device is to be used in a mirror, the second surface is typically defined by a relatively thin layer of transparent conductor such as indium tin oxide, doped tin oxide or doped zinc oxide deposited on another glass substrate, which is silvered or aluminized or otherwise reflector coated on its opposite side. In the case of solar control windows, the second glass substrate would of course not be silvered on its opposite side so that when the redox pair is colorless, the window would be entirely transparent.

UV stabilizers such as benzotriazoles, benzophenones, or hindered amine complexes, as known in prior art, are usually added to the electrochemichromic solution to help increase solution stability to UV radiation, but there are limitations and disadvantages to addition of UV stabilizers. Because they are held in solutions of low to moderate viscosity, both the UV stabilizer and the electrochemichromic solutes are free to randomly move about in the solution. Thus, an incoming photon of UV radiation may impinge and thus degrade an electrochemichromic solute species rather than be absorbed by a UV absorber in solution. Also, solubility within the selected solvent places limits on the amount of UV stabilizer that can be added.

Certain viologen salts have been known to be used as cathodic coloring species in electrochemichromic solutions. These known viologen salts include salts of methylviologen, heptylviologen, phenylviologen, and benzylviologen being most commonly described. Examples of electrochemichromic solutions containing these viologen salts are described in U.S. Pat. Nos. 3,806,229, 3,912,368, 3,774,988, 3,873,185, 3,652,149, 3,692,388, 4,902,108, 4,210,390, and 3,854,794, Japanese Application Nos. 56-93743 and 56-93742, European Patent Application No. 0012419, U.S.S.R. Patent No. 566,860, I. V. Shelepin, et al., Elektrokhimiya, vol. 13(3), 404-408, (March 1977) and O. A. Ushakov, et al., Electrokhimya, vol. 14(2), 319-322, (February 1978). However, thus far, prior art electrochemichromic solutions have included a relatively limited number of viologen salts as cathodic coloring species.

### SUMMARY OF THE INVENTION

The first object of the present invention is to provide novel viologen compounds which function well as cathodic species in electrochemichromic solutions.

A second object of the present invention is to provide a novel viologen compound which enhances the UV stability of electrochemichromic solutions without the need for additional UV stabilizers.

Also, whereas with applications such as rearview mirrors which are principally only dimmed at night such that their UV stability when held in the colored state is not of primary importance, for disparate applications such as automotive sunroofs and the like, it is critical that the ECC device be UV stable in both its bleached and its colored state. Indeed, for applications such as dimmable building windows and automotive glazing, it is more likely that exposure to intense solar radiation will occur while the window is dimmed rather than when it is bleached. Thus, another objective of this invention is to describe specific novel compounds, including a description of a novel compound that achieves superior UV stability, particularly in the colored state.

More specifically, the present invention provides novel viologen salts having one of the following chemical formulae:

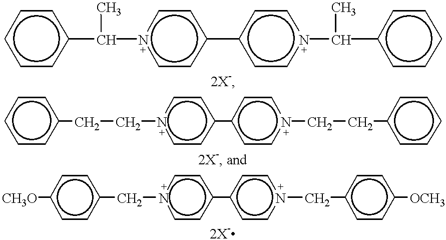

wherein X⁻ is an anion.

The present invention also provides an electrochemichromic solution comprising:

a solvent;

a redox chemical pair comprising a cathodic material and an anodic material, wherein the cathodic material is a viologen salt selected from one of the above-listed viologen salts.

### DESCRIPTION OF THE PREFERRED EMBODIMENT

Viologen salts are the preferred cathodic coloring materials for the redox pair in electrochemichromic solutions. Viologen salts have the following general formula (I):

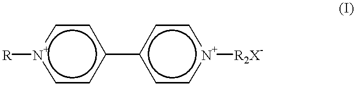

wherein R is an aliphatic, substituted aliphatic, aryl, or substituted aryl group, X⁻ is the anion of the viologen salt. Various anions are disclosed in the literature, though we have discovered that the most preferred anions are hexafluorophosphate (PF₆⁻) and hexafluoroarsenate (AsF₆⁻) because they surprisingly enhance viologen solubility. Viologen counterions are listed below:

| | |
|---|---|
| Tetrafluoroborate | BF₄⁻ |
| Perchlorate | ClO₄⁻ |
| Trifluoromethane sulfonate | CF₃SO₃⁻ |
| Hexafluorophosphate | PF₆⁻ |
| Hexafluoroarsenate | AsF₆⁻ |

The novel viologens according to the present invention have the following chemical formulae:

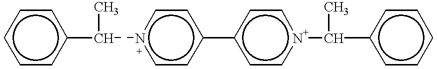

1,1′-bis(1-phenylethyl)-4,4′-bipyridinium or

α-phenyl ethyl viologen (α-PEV)

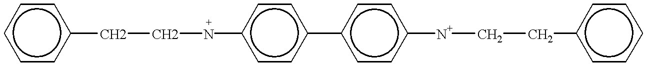

1,1′-bis(2-phenylethyl)-4,4′-bipyridinium or

β-phenyl ethyl viologen (β-PEV)

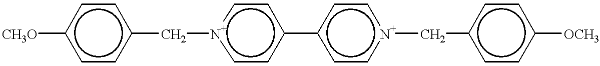

1,1′-bis(4-methoxybenzyl)-4,4′-dipyridinium or

methoxy benzyl viologen (MBV)

These viologens were prepared, as detailed later, by reacting 4,4′-dipyridyl with the corresponding alkyl halide in acetonitrile under reflux conditions and with subsequent conversion from the viologen halide to the desired viologen salt by treatment with the corresponding lithium salt in methanol or water.

The present inventors have discovered that β-PEV greatly enhances the UV stability of electrochemichromic solutions without the need for additional UV stabilizers.

The present inventors have also discovered that viologen salts having the general formula I wherein R is a straight chain aliphatic group having 5 carbons or less greatly enhances the UV stability of electrochemichromic solutions without the additional need for UV stabilizers. Examples of such viologens are methylviologen, wherein R in general formula I is a methyl group, and ethylviologen, wherein R is an ethyl group.

The present inventors further discovered that viologen salts having the general formula (I), wherein R is a straight chain aliphatic group having 5 carbons or less and β-PEV salt greatly enhance the UV stability of electrochemichromic solutions that utilize such viologen salts even when the electrochemichromic solutions are colored to a dimmed state by the application of an applied potential. Enhanced UV stability in the colored state is advantageous to devices that utilize such electrochemichromic solutions to achieve a dimmed, light attenuating state under circumstances where exposure to ultraviolet radiation while the device is dimmed is to be expected. An example of such device would be a sunroof in a vehicle.

The anodic coloring materials which may be used with the viologens of the present invention include conventional anodic materials. The preferred ones are set forth below:

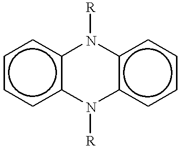

DMPA—5,10-dihydro-5,10-dimethylphenazine R—CH₃

DEPA—5,10-dihydro-5,10-diethylphenazine R—C₂H₅

DOPA—5,10-dihydro-5,10-dioctylphenazine R—C₈H₁₇

TMPD—N,N,N′,N′-tetramethylphenylenediamine

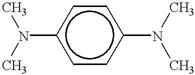

TMBZ—N,N,N′,N′—tetramethylbenzidine

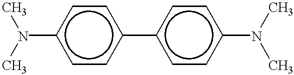

TTF—Tetrathiafulvalene

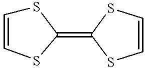

TBFE—Tertiary butyl ferrocene

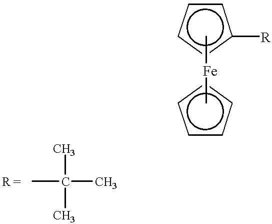

Most preferred is a 0.025 molar solution of 5,10-dihydro-5,10-dimethylphenazine (DMPA) or a 0.04 molar solution of tertiary butyl ferrocene (TBFE).

Numerous electrolytes can be optionally used in the present invention. One which is acceptable in accordance with the preferred embodiment of the invention is a tetrabutylammonium hexafluorophosphate. We prefer a 0.025 molar solution.

UV stabilizers such as Uvinul™ 400 (2,4-dihydroxybenzophenone) at approximately 5% weight by volume can also be used in the solutions of the present invention. As explained, viologens whose R group is a straight chain aliphatic group having 5 carbons or less and the novel viologen β-PEV greatly enhance UV stability of the electrochemichromic solutions. Accordingly, for solutions containing salts of these viologens, additional UV stabilizers are not required.

The solvent for the electrochemichromic solution according to the present invention may be any conventional solvents such as acetonitrile, propylene carbonate, N-methylpyrrolidone, gamma-butyrolactone, methyl ethyl ketone, dimethylformamide and the like. The preferred solvents are the solvent systems disclosed in parent U.S. patent application Ser. Nos. 07/443,113 and 07/458,969, the disclosures of which are hereby incorporated by reference.

These solvents include glutaronitrile (GNT) and solvents comprising at least 25% by volume of glutaronitrile mixed with other solvents such as 3-hydroxypropionitrile (HPN), 3,3′-oxydipropionitrile (ODPN), 3-methylsulfolane (MS), and propylene carbonate (PC), and other solvents common to electrochemichromic devices. Electrolytes may optionally be used and are preferably used.

The following Examples are provided to show various aspects of the present invention without departing from the scope and spirit of the invention.

### EXAMPLE 1

### Synthesis of α-Phenyl Ethyl Viologen Tetrafluoroborate (α-PEVBF₄)

About 10 gms (0.064 moles) of 4,4′-dipyridyl was dissolved in 160 ml of acetonitrile in a 500 ml flask. To this solution, excess (1-bromoethyl)benzene (22 ml) was then added through a glass funnel. 20 ml of acetonitrile was then used to wash the funnel directly into the reaction flask. The solution was refluxed for about 15 hours. Yellow precipitate appeared after about 2 hours of refluxing and the amount of the precipitate increased with time. After refluxing was completed, the resultant mixture was filtered and the precipitate obtained was washed with acetonitrile, and air dried. A yield of 24 gms of α-phenyl ethyl viologen dibromide (α-PEVBr₂) was obtained (71%).

About 10 gms (0.02 mole) of α-PEVBr₂ thus prepared was then dissolved in 100 ml of deionized water. About 4.2 gms (0.045 mole) of lithium tetrafluoroborate (LiBF₄) was dissolved in another 50 ml of deionized water. These two solutions were then mixed and warmed in a water bath at 45-50° C. α-phenyl ethyl viologen tetrafluoroborate (α-PEVBF₄) precipitated instantenously. The precipitates obtained were filtered and dried under a vacuum. The yield for α-PEVBF₄ obtained was 4.5 gms (42%).

### EXAMPLE 2

### Synthesis of β-Phenyl Ethyl Viologen Tetrafluoroborate (β-PEVBF₄)

About 10 gms (0.064 moles) of 4,4′-dipyridyl was dissolved in 180 ml of acetonitrile in a 500 ml flask. To this solution, excess (2-bromoethyl)benzene (22 ml) was added. The resultant solution was then refluxed for about 12-15 hours. β-phenyl ethyl viologen dibromide (β-PEVBr₂) precipitated after about 2 hours of refluxing and the amounts of precipitate increased with time. After refluxing was completed, the resultant mixture was then filtered, and the precipitate obtained was washed with acetonitrile and air dried. A yield of 50 gms (wet compound) of β-PEVBr₂ was obtained.

About 26.3 gms of β-PEVBr₂ (wet compound) thus prepared was dissolved in methanol (200 ml)/H₂O (50 ml) by heating at 50-60° C. 9.5 gms of LiBF₄ dissolved in 100 ml of methanol was then added to the β-PEVBr₂ solution. The resultant solution was then heated in a water bath for about 10 minutes at 45-50° C. and then cooled. Upon cooling, β-phenylethyl viologen tetrafluoroborate (β-PEVBF₄) precipitated immediately. The resultant mixture was then filtered, and the precipitate obtained was washed with methanol and dried in a vacuum. The yield for β-PEVBF₄ was 10 gms.

### EXAMPLE 3

### Synthesis of Methoxy Benzylviologen Tetrafluoroborate (MBVBF₄)

In a 100 ml flask, 3.0 gms (0.0192 moles) of 4,4′-dipyridyl was dissolved in 60 ml of acetonitrile. To this solution, 6.2 gms (0.0397 moles) of p-methoxy benzyl chloride was added. No precipitation was observed at room temperature. The resultant solution was then heated and refluxed for about 2 hours. Upon heating, precipitate appeared, and the amount of precipitate increased with time. After refluxing was completed, the resultant mixture was cooled and filtered. The product methoxy benzyl viologen dichloride (MBVCl₂) was then washed with acetonitrile and used in the next step.

MBVCl₂ thus prepared was then dissolved in a minimum amount of methanol. To this solution, 4.0 gms of LiBF₄ dissolved in methanol was then added. The resultant solution was then heated in a water bath for about 15 minutes at 45-50° C. and then cooled. The resultant mixture was then filtered to obtain a product of 5.3 gms (48%) of methoxy benzyl viologen tetrafluoroborate (MBVBF₄). The product was then recrystallized from boiling water, filtered, washed with methanol, and then dried under a vacuum.

The following example illustrates the UV stability of viologen salts whose R group is a straight chain alkyl group having 5 carbons or less and the novel β-PEV salt according to the present invention.

### EXAMPLE 4

Electrochemichromic rearview mirrors with solutions containing 0.025M of the viologen salts shown in Table 1 and 0.025M of 5,10-dihydro-5,10-dimethylphenazine (DMPA) in propylene carbonate were exposed to a xenon arc lamp and were irradiated with UV radiation that closely simulated the solar intensity for periods up to about 215 hours. The results are shown in Table 1.

TABLE 1

| | Irradi- | High | Low | Color | Bleach |
|---|---|---|---|---|---|
| Viologen | ation | Reflect- | Reflect- | 70%-20% R | 10%-60% R |
| Salts | Periods | ance % | ance % | Sec. | Sec. |
| Methyl- | initial | 77.7 | 5.2 | 2.45 | 4.81 |
| viologen | 32 hrs | 77.6 | 6.4 | 3.28 | 5.06 |
| tetraflu- | 100 hrs | 75.7 | 6.1 | 2.80 | 4.47 |
| oroborate | 215 hrs | 75.2 | 5.1 | 2.13 | 5.24 |
| Ethyl- | initial | 82.8 | 5.8 | 2.68 | 4.29 |
| viologen | 32 hrs | 80.6 | 5.8 | 2.46 | 4.34 |
| tetraflu- | 100 hrs | 78.6 | 6.8 | 2.50 | 4.17 |
| oroborate | 215 hrs | 77.2 | 5.9 | 2.06 | 4.75 |
| ρ-PEV | initial | 79.6 | 4.9 | 2.15 | 4.66 |
| tetraflu- | 32 hrs | 78.7 | 4.6 | 2.15 | 5.48 |
| oroborate | 100 hrs | 75.2 | 4.9 | 1.97 | 6.07 |
| | 215 hrs | 74.3 | 5.9 | 2.17 | 5.94 |
| Benzyl | initial | 80.8 | 5.1 | 1.49 | 5.35 |
| viologen | 32 hrs | 63.1 | 5.2 | 1.72* | 5.71** |
| tetraflu- | 100 hrs | 42.4 | 4.7 | 1.26* | 7.10** |
| oroborate | 215 hrs | 42.0 | 4.9 | 1.23* | 8.62* |

*seconds to color from high reflectance % to 20%.
**seconds to bleach from 10% to high reflectance %.

The last four columns of Table 1 measures reflectivity data. Reflectivity is measured in a conventional manner using a standard illuminant and a photodetector that reproduces the eyes photopic response and is expressed as a percentage of incident light which is reflected by the mirror. High reflectance percentage is measured when the electrochemichromic solution is at zero potential and thus is colorless. Low reflectance percentage is determined when the electrochemichromic solution is colored at 1 volt applied potential.

The fifth column measures the time in seconds that it takes for the solution to color from 70% reflectivity to 20% reflectivity. The sixth column indicates in seconds the time it takes for the solution to bleach from 10% reflectivity to 60% reflectivity.

Table 1 shows that the electrochemichromic solutions containing methylviologen tetrafluoroborate and ethylviologen tetrafluoroborate exhibit high UV stability since they maintain their high reflectance state. In contrast, the electrochemichromic solution containing benzylviologen tetrafluoroborate was unstable since its high reflectance state dropped from 80.8% to 42% after 215 hours of irradiation, principally due to yellowing.

The results also show that β-PEV tetrafluoroborate, one of the novel viologen salts according to the present invention, shows high UV stability since the electrochemichromic solution containing this viologen salt was able to maintain its high reflectivity state.

We also find that electrochemichromic solutions containing methylviologen, ethylviologen and β-PEV exhibit high UV stability regardless of whether such solutions are in their bleached state or are in their colored state while being exposed to weathering. For example, an electrochemichromic mirror containing 0.025M of methylviologen perchlorate and 0.04M of tertiary butyl ferrocene in propylene carbonate which is repetitively bleached/colored under a cycle comprising 30 seconds of bleach at zero applied potential and 30 seconds of coloration under 1 volt applied potential, while placed in a solar simulator where the mirror is exposed to intense UV radiation along with elevated temperatures of 70° Celsius and greater, retains its high reflectance state and continues to be commercially usable even after several months of such repetitive bleaching and coloring in the presence of intense UV irradiation and high temperature.

While the present invention has been described with respect to what is presently considered to be the preferred embodiments, it is to be understood that the invention is not limited to the disclosed embodiments. The present invention is intended to cover various and equivalent formulations included within the spirit and scope of the appended claims.

What is claimed is:

1. An electrochemichromic solution comprising:
a solvent;
a redox chemical pair comprising a cathodic material and an anodic material, wherein said cathodic material is selected from one of the following viologen compounds: 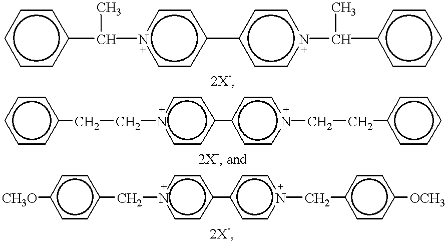
wherein X⁻ is an anion.

2. An electrochemichromic solution according to claim 1, wherein said anion is selected from a group consisting of tetrafluoroborate, perchlorate, trifluoromethane sulfonate, hexafluorophosphate, and hexafluoroarsenate.

3. An electrochemichromic solution according to claim 1, wherein said viologen compound is

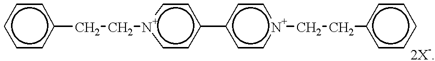

4. A viologen salt having one of the following chemical formulae. 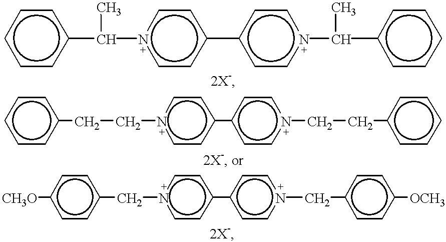
wherein X⁻ is an anion.
